(19) United States
(12) Patent Application Publication
(10) Pub. No.: US 2010/0229103 A1
(43) Pub. Date: Sep. 9, 2010

(54) System and method for conference management

(76) Inventors: Yu-Jen Lin, Hsin-Chu (TW); Chih-Lung Chang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,504

(22) Filed: Jun. 12, 2009

(30) Foreign Application Priority Data
Mar. 5, 2009 (TW) 098107094

(51) Int. Cl. G06F 3/01

(52) U.S. Cl. 715/753

(57) ABSTRACT

The present invention relates to a system for conference management and a method for conference management. The system for conference management comprises a gateway including a conference control module; a plurality of computers connected to the gateway by a network, each of the computers storing a report content respectively; and a large sized display connected to the gateway. By using the conference control module to manage the rights of display of the computers, the computer that is granted the right of display transmits the report content to the gateway, and displays on the large sized display for information communication.

### FIELD OF THE INVENTION

The present invention relates to a system for conference management and a method for conference management.

### BACKGROUND OF THE INVENTION

Nowadays, it is convenient for people to edit a report by using a computer. Instead of printing the report to a stack of transparencies, people use a projector that is connected to a computer storing the report to display the report in a conference.

Referring to FIG. 1, there is shown a schematic diagram of a conference system in accordance with the prior art. A person who reports in a conference uses a computer 14 to store the report content 141. The computer 14 is connected to a projector 12 by a cable 16, and the report content 141 is projected to a screen 18 by the projector 12. People who join the conference can read the report content 141 from the screen 18.

In general, a projector 12 can only be connected to a computer 14. If there are many reporters in the conference, the projector 12 will be disconnected with one computer and connected to another computer again and again. It would be much inconvenient for the reporters, and the audiences would be kept waiting frequently. The conference system in accordance with the prior art is inefficient for information communication.

### SUMMARY OF THE INVENTION

It is the primarily objective of the present invention to provide a system for conference management and a method for conference management.

It is another objective of the present invention to provide a system for conference management, wherein the gateway comprises a conference control module for managing the rights of display of a plurality of computers.

It is another objective of the present invention to provide a system for conference management, wherein the gateway is connected with a large sized display for displaying the report content from the computer that is granted the right of display.

It is another objective of the present invention to provide a system for conference management, wherein the conference control module can be selected to operate in a shared mode or an exclusive mode for different types of conference.

It is another objective of the present invention to provide a method for conference management, wherein computers that are logged in to the conference control module are configured to be granted the right of display or not, computers that is granted the right of display can transmit the report content to a gateway, and display the report content on a large sized display.

It is another objective of the present invention to provide a method for conference management, wherein the conference control module can be selected to operate in a shared mode or an exclusive mode for different types of conference.

It is another objective of the present invention to provide a method for conference management, wherein the computer that is displaying the report content can be selected to play, pause, or stop the report content.

It is another objective of the present invention to provide a method for conference management, wherein the conference control module grant all computers the rights of display in shared mode.

It is another objective of the present invention to provide a method for conference management, wherein the conference control module grant only one computer the right of display.

The present invention provides a system for conference management, comprising: a gateway including a conference control module; a plurality of computers connected to the gateway by a network, each of the computers storing a report content respectively; and a large sized display connected to the gateway; wherein each of the computers transmits the report content to the gateway and displays on the large sized display according to the right of display managed by the conference control module.

The present invention further provides a method for conference management, comprising the steps of: providing a gateway, a large sized display, and a plurality of computers, each computer connected to the gateway by a network; providing a conference control module; logging the computers in to the conference control module; managing the rights of display of the computers by the conference control module; transmitting the report content from the computer that is granted the right of display to the gateway, and displaying the report content on the large sized display.

### BRIEF DESCRIPTION OF THE DRAWINGS

FIG. 1 is a schematic diagram of a conference system in accordance with the prior art.

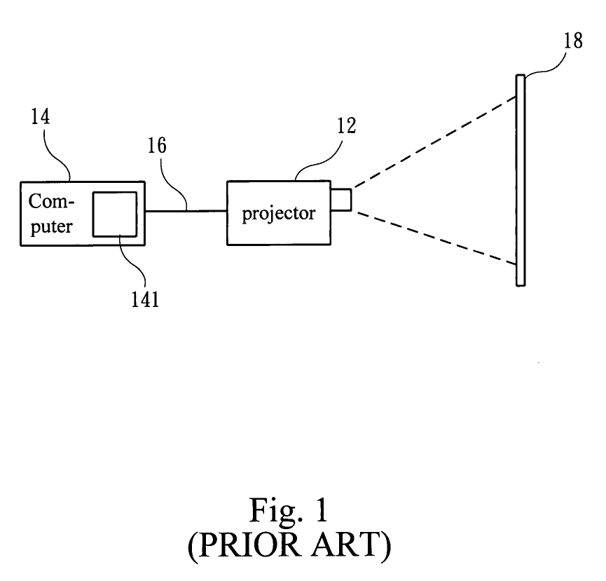

FIG. 2 is a schematic diagram of a system for conference management in accordance with an embodiment of the present invention.

FIG. 3 is a flow chart illustrating a method for conference management in accordance with an embodiment of the present invention.

FIG. 4 is an interaction diagram of an embodiment of the present invention in shared mode.

FIG. 5 is an interaction diagram of an embodiment of the present invention in exclusive mode.

### DETAILED DESCRIPTION OF DISCLOSED EMBODIMENTS

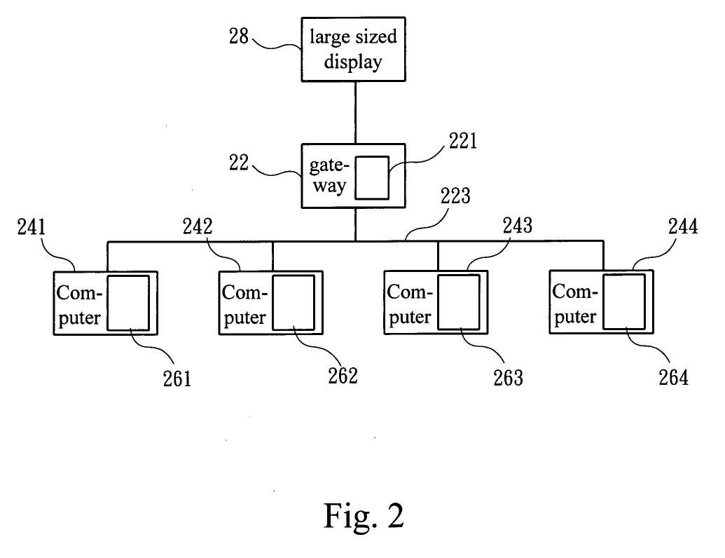

Referring to FIG. 2, there is shown a schematic diagram of a system for conference management in accordance with one embodiment of the present invention. The system for conference management of the present invention comprises a gateway 22, a plurality of computers (such as computers 241, 242, 243, and 244), and a large sized display 28, wherein each computer 241, 242, 243, and 244 stores a report content 261, 262, 263, and 264.

The gateway 22 comprises a conference control module 221. Each computer 241, 242, 243 and 244 is connected to the gateway 22 by a network 223. The gateway 22 is connected with the large sized display 28.

In a conference, computers 241, 242, 243, and 244 are connected to the gateway 22 by the network 223, and logged in to the conference control module 221 respectively. The conference control module 221 manages the rights of display of the computers 241, 243, 243, and 244. The computer 241, 242, 243, or 244 that is granted the right of display can transmit the report content 261, 262, 263, or 264 to the gateway 22, and displays the report content on the large sized display 28 for the reviewing of the audiences.

The conference control module 221 can operate in a shared mode or an exclusive mode. In shared mode, computers 241, 242, 243, and 244 that are logged in to the conference control module 221 are granted the rights of display. Each computer can transmit the report content to the gateway 22, and display the report content on the large sized display 28 for information communication.

While the conference control module 221 operates in exclusive mode, the conference control module 221 grants only one computer the right of display, such as the computer 242. Then, only computer 242 can transmit the report content 262 to the gateway 22, and display the report content 262 on the large sized display 28. When the user of the computer 243 wishes to display the report content 263, a request is transmitted from the computer 243 to the computer 242 for asking the right of display. If the user of the computer 242 agrees, the conference control module 221 will revoke the right of display of the computer 242, and grant the right of display to the computer 243. Then, the computer 243 can transmit the report content 263 to the gateway 22 and display on the large sized display 28.

When displaying, the user of the displaying computer can decide to play, pause, or stop the report content.

In the present embodiment, the large sized display 28 is selected from one of a large sized liquid crystal display (LCD), a light emitting diode (LED) display, or a projector. The network 223 is selected from one of a wired network or a wireless network. The conference control module 221 can operate in the gateway 22, or be downloaded to the computers and operate in each computer.

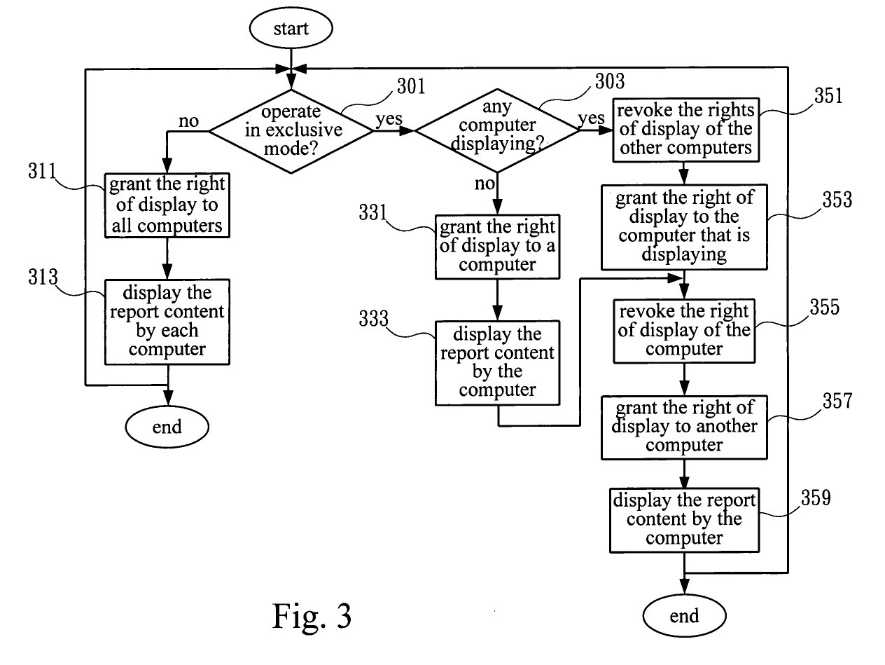

Referring to FIG. 3, there is shown a flow chart illustrating a method for conference management in accordance with an embodiment of the present invention.

The method for conference management of the present invention is applied on the aforementioned system for conference management in FIG. 2. After the computers are connected to the gateway 22 and logged in to the conference control module 221, the method for conference management comprises steps as the following.

Firstly, a user selects the operation mode of the conference control module 211. The conference control module 211 determines if the conference control module 211 operates in exclusive mode in step 301. If the conference control module 221 does not operate in exclusive mode, namely, operates in shared mode, the conference control module 221 grants the rights of display to each of the computers in step 311. Each computer transmits the report content stored therein to the gateway 22 and displays on the large sized display 28 according to the process of the conference in step 313.

If the conference control module 221 operates in exclusive mode, or is turned from the shared mode to the exclusive mode, it determines if there is any computer displaying the report content in step 303. If there is no computer displaying the report content, the conference control module 221 grants the right of display to a computer in step 331. The computer that is granted the right of display transmits the report content stored therein to the gateway 22, and displays the report content on the large sized display in step 333.

If there is a computer displaying the report content, the conference control module 221 revokes the rights of display of all other computers in step 351, and grants the right of display to the computer that is currently displaying the report content in step 353.

If the computer in step 333 or 353 terminates the report content or there is another user asking for displaying the report content, the conference control module 221 revokes the right of display of the computer that previously displayed the report content in step 355. Then the conference control module 221 grants the right of display to the computer that is going to display the report content in step 357. The computer that is granted the right of display transmits the report content stored therein to the gateway 22, and displays the report content on the large sized display 28 in step 359.

In the method for conference management of the present invention, the conference control module 221 can change the operation mode according to the requirement of the users during the conference. When the operation mode is changed, the process goes to step 301 for determining the operation mode again. In the method for conference management of the present invention, can also change the operation mode according to the type of the conference, the pace of the conference, or the level of the attendees. The reporter can play, pause, or stop the display of the report content according to the condition of the conference scene to set the pace and efficiency of the conference.

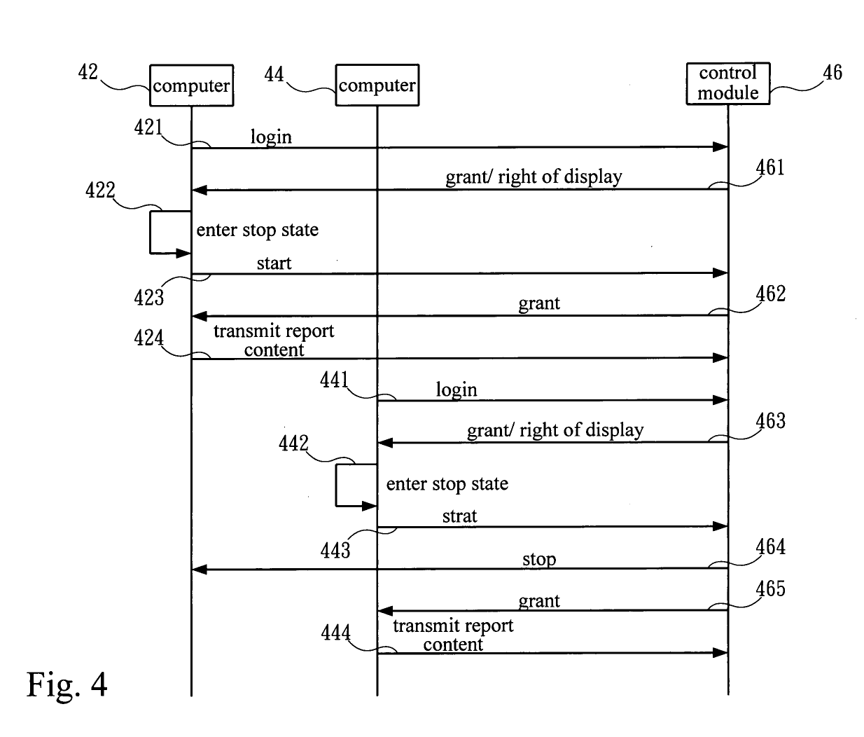

Referring to FIG. 4, there is shown an interaction diagram of an embodiment of the present invention in shared mode. In a conference where the conference control module operates in shared mode. A computer 42 transmits a signal of login request 421 to the conference control module 46. The conference control module 46 replies a signal of login granted and the right of display granted 461 to the computer 42. The computer 42 enters a stop state 422 first. When the reporter wants to display the report content, the computer 42 transmits a signal of start request 423 to the conference control module 46. If the conference control module 46 replies a signal of start granted 462, the computer 42 transmits the report content 424 to the conference control module 46 (gateway), and displays the report content on a large sized display.

When a computer 44 transmits a signal of login request 441 to the conference control module 46, the conference control module 46 also replies a signal of login granted and the right of display granted 463 to the computer 44. The computer 44 enters a stop state 442. If the user of the computer 44 wants to display the report content, the computer 44 transmits a signal of start request 443 to the conference control module 46.

In this case, the conference control module 46 stops 464 the computer 42, and replies a signal of start granted 465 to the computer 44. The computer 44 then transmits the report content 444 to the gateway, and displays the report content on the large sized display.

The aforementioned embodiment is described in the case of two joining computers 42 and 44. The interaction of the case of more joining computers may be deduced by analogy.

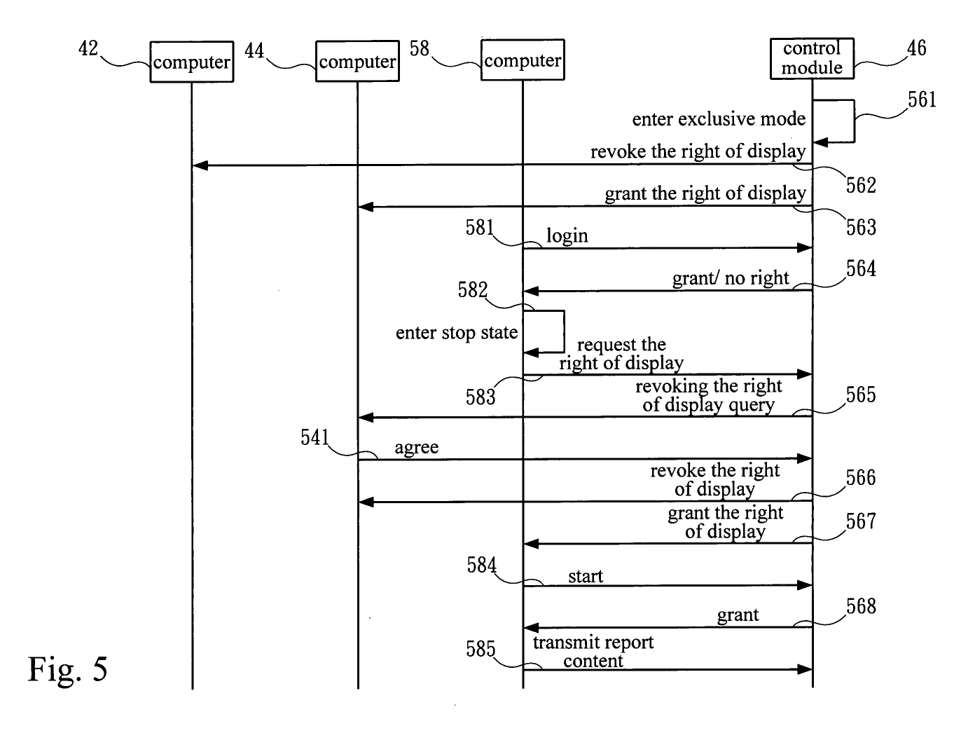

Referring to FIG. 5, there is shown an interaction diagram of an embodiment of the present invention in exclusive mode. Here, the conference control module 46 changes the operation mode from the shared mode of FIG. 4 to an exclusive mode. The conference control module 46 enters the exclusive mode 561 first.

According to FIG. 4, the computer 44 is currently displaying the report content. So the conference control module 46 revokes the right of display 562 of the other computer (such as computer 42), and grants the right of display 563 to the computer 44. The computer 44 continues displaying the report content.

If there is any computer (such as computer 58) joining to the conference, the computer 58 transmits a signal of login request 581 to the conference control module 46. Since the conference control 46 operates in exclusive mode, it replies a signal of login granted but no right of display 564 to the computer 58. Then the computer 58 is logged in and enters a stop state 582.

During the conference, if a user of the other computer (such as computer 58) wants to display the report content, the computer 58 transmits a signal of request of the right of display 583 to the conference control module 46. In this case, the conference control module 46 firstly transmits a signal of revoking the right of display query 565 to the computer 44. If the computer 44 replies a signal of agree 541, then the conference control module 46 revokes the right of display 566 of the computer 44, and grants the right of display 567 to the computer 58.

Then the computer 58 transmits a signal of start request 584 to the conference control module 46. If the conference control module 46 replies a signal of start granted 568, the computer 58 transmits the report content 585 to the gateway, and displays the report content on the large sized display.

In case of more joining computers, the interaction of the conference in exclusive mode may be deduced by analogy.

The present invention is not limited to the above-described embodiments. Various alternatives, modifications and equivalents may be used. Therefore, the above embodiments should not be taken as limiting the scope of the invention, which is defined by the appending claims.

What is claimed is:

1. A system for conference management, comprising:
a gateway including a conference control module;
a plurality of computers connected to said gateway by a network, each of said computers storing a report content respectively; and
a large sized display connected to said gateway;
wherein each of said computers transmits the report content to the gateway and displays on the large sized display according to the right of display managed by the conference control module.

2. The system of claim 1, wherein said network is selected from one of a wired network and a wireless network.

3. The system of claim 1, wherein said large sized display is selected from one of a large sized liquid crystal display, a light emitting diode display and a projector.

4. The system of claim 1, wherein said conference control module can be downloaded to said plurality of computers, and operate on said plurality of computers.

5. The system of claim 1, wherein said conference control module can operate selectively in one of a shared mode or an exclusive mode.

6. The system of claim 5, wherein if said conference control module operates in shared mode, it grants the rights of display to all of said plurality of computers.

7. The system of claim 5, wherein if said conference control module operates in exclusive mode, it grants the right of display to only one of said plurality of computers.

8. The method for conference control management, comprising the steps of:
providing a gateway, a large sized display, and a plurality of computers, wherein each computer is connected to said gateway by a network, wherein each computer stores a report content;
providing a conference control module;
logging each computer in to said conference control module;
managing the right of display of each computer by the conference control module;
transmitting said report content stored in the computer that is granted the right of display to the gateway; and
displaying said report content on said large sized display.

9. The method of claim 8, wherein said conference control module can operate selectively in one of a shared mode or an exclusive mode.

10. The method of claim 9, further comprising a step of selecting said conference control module to operate in one of said shared mode or said exclusive mode.

11. The method of claim 10, wherein if said conference control module operates in shared mode, it grants the rights of display to all of said plurality of computers.

12. The method of claim 11, wherein each computer that is displaying said report content can select to play, pause, or stop said report content.

13. The method of claim 10, wherein if said conference control module operates in exclusive mode, it grants the right of display to only one of said plurality of computers, and said computer that is granted the right of display displays said report content on said large sized display.

14. The method of claim 13, wherein said computer that is granted the right of display can select to play, pause, or stop said report content.

15. The method of claim 13, further comprising steps of:
revoking the right of display of said computer that is previously granted the right of display; and
granting the right of display to another one of said plurality of computers.

16. The method of claim 10, wherein said conference control module can change operation mode from shared mode to exclusive mode or vice versa according to the requirement of the conference.
